(19) United States
(12) Patent Application Publication
(10) Pub. No.: US 2017/0097645 A1
(43) Pub. Date: Apr. 6, 2017

(54) SUBJECT TRACKING SYSTEM FOR AUTONOMOUS VEHICLES

(71) Applicant: Jeffrey Clyne GARLAND, Oceanside, CA (US)

(72) Inventor: Jeffrey Clyne GARLAND, Oceanside, CA (US)

(21) Appl. No.: 14/562,020

(22) Filed: Dec. 5, 2014

Related U.S. Application Data
(60) Provisional application No. 61/912,018, filed on Dec. 5, 2013.

(51) Int. Cl. G05D 1/12; G05D 1/00; B64D 47/08; G01C 21/16; B64C 39/02

(52) U.S. Cl. CPC G05D 1/12; G01C 21/16; B64C 39/024; B64D 47/08; G05D 1/0088

(57) ABSTRACT

A subject tracking system to track a subject is provided. The subject tracking system may include a sensor system, a transmitting unit and a processor. The transmitting unit may be configured to be located with the subject during use and comprising at least one first dedicated high frequency oscillator. The sensor system may include at least one second dedicated high frequency oscillator to continually synchronize the transmitting unit and the sensor system. The processor may continually determine changes in the distance between the subject and the subject tracking system so that a distance between the subject and the autonomous vehicle can be maintained.

### CROSS-REFERENCE TO RELATED APPLICATIONS

This application claims priority to U.S. Provisional Application No. 61/912,018, filed on Dec. 5, 2013, which is hereby incorporated by reference in its entirety.

### FIELD OF SOME EMBODIMENTS OF THE INVENTION

Embodiments of the invention relate to the field of ultrasonic measuring and tracking systems and, more particularly, a system for directly measuring the change in distance to and the angular position of an emitter, enabling an autonomous vehicle with a camera to follow a moving subject and maintain a constant distance.

The ability to follow a subject with an autonomous mobile video platform is desired. This capability is useful for filming action sports.

### BACKGROUND

The state of the art of camera systems for action sports include subject and vehicle mounted cameras. Subject mounted cameras provide a “Ride along” view. These include athlete mounted, such as helmet or backpack mounts and equipment mounted, such as ski, surfboard, and bike mounts. Subject mounted cameras can't see the athlete from an independent “follower” view point.

Airborne vehicles such as quad copters are also used as camera platforms. An airborne vehicle can see the entire athlete in their surroundings. These provide an independent platform that is not influenced by the subject's jarring bumps, impacts, or crashes. These vehicles are typically remotely piloted or GPS guided.

Remotely piloted vehicles can be operated by a pilot observing the subject via a first person video connection. This requires a dedicated pilot in addition to the person that is the subject of the video.

GPS guided vehicles have also been used as camera platforms. In this approach the vehicle receives the coordinates of a GPS receiver attached to or worn by the subject. The vehicle compares the coordinates of its own GPS receiver with those of the subject and directs itself toward the subject's coordinates. GPS guided vehicles require a clear view of the sky and their proximity to the subject is limited to a minimum separation distance of 40 feet or more due to the accuracy of GPS.

Autonomous Stationary Cameras have also been used to capture a moving subject. Examples exist that utilize ultrasonic range finding and that utilize GPS. U.S. Pat. No. 4,980,871 describes how to aim a camera horizontally and vertically at an ultrasonic beacon worn by the subject. For an autonomous mobile platform this technology is not enough, the distance to the subject should also be known. Therefore, the technology described prior to the present application fails to teach methods and systems for a moving autonomous vehicle to follow a moving subject at a desired distance.

Prior products use GPS to point a camera at a subject wearing a beacon. This technology requires the camera unit to be stationary which would not be practical for mobile applications. Additionally, this technology can only be used be used outdoors where GPS signals are available, making it unavailable for indoor use.

An autonomous mobile camera platform that is intended to follow a subject needs the capability to measure the distance to its subject. Ultrasonic range finders are typically used for this task. For example, one device may include an ultrasonic range finding system that is often used with quad-copters to detect and measure the distance to obstacles. They can have a range of up to 35 feet. These range finders detect any reflecting surface within a few degrees of their line of sight. These sensors work by sending out an ultrasonic (“US”) pulse and listening for the echo to return to their receiver. These systems measure the length of time required for a sound wave to travel to and from the reflecting object. The distance to the object is equal to the half the time divided by the speed of sound. There is a line of products based on this patent and their stated resolution is 0.4 inches. These systems have the required resolution but can't measure the distance to a specific object which is necessary for a follower system.

Another device may include a vehicle and transmitter incorporating an ultrasonic range finding system between them. The systems on the vehicle and transmitter are synchronized by a radio wave signal. The radio wave signal is sent form the subject's transmitter to the follower's receiver. The distance between the two is proportional to the difference in the two signal's arrival times.

Yet another device may include a vehicle and transmitter incorporating an ultrasonic range finding system between them. The systems on the vehicle and transmitter are synchronized by an ultrasonic signal. The follower initiates synchronization by sending out a US signal, the subject unit receives this signal and send back its own US signal. The distance between the two is proportional to the amount of time between when its US signal is sent and when the subject's US signal is received after and delays have been subtracted.

Another device may include a system that incorporates multiple range finding methodologies including ultrasonic. The systems on the vehicle and subject are synchronized by a transmission system between their processors.

Yet still another device may include a cart for a golf bag that follows a golfer. The system synchronizes with an initial RF signal from the subject system to the follower. The follower then sends two US signals to the subject system. The subject receives the US signals and sends the arrival time information back to the follower via a RF signal. The follower uses the data received from the subject to control the vehicle.

There is another device that relates to a system that includes ultrasonic, infrared (“IR”), and radio frequency (“RF”) communications. The system's follower sends US and IR signals to the subject unit and the subject unit sends RF signals to the follower. The distance between the two is proportional to the difference in the arrival time of the US and IR signals. The subject unit communicates the distance data to the follower via RF.

There is a need for a less complex sensor system for an autonomous mobile follower camera platform with improved capabilities so that a subject can be followed from closer than 50 feet. This sensor system can measure changes in the distance between the sensor system and an emitter within a few inches, measure the angular position of the emitter, and function indoors and outdoors. This sensor system leverages the limited flight time (15 minutes) of autonomous copters which allows for a system that accumulates a limited amount of error.

### BRIEF SUMMARY OF THE INVENTION

Embodiments of the present application address many of the above issues. For example, one embodiment of the present application relates to a tracking system that measures changes in the distance to and the angular position of an emitter enabling an autonomous vehicle to follow a subject. The tracking system may include an emitter, a sensor system, and a synchronization system.

According to one embodiment, a subject tracking system to track a subject, the subject tracking system may include a sensor system, a transmitting unit and a processor. The transmitting unit may be configured to be located with the subject during use and comprising at least one first dedicated high frequency oscillator. The sensor system may include at least one second dedicated high frequency oscillator to continually synchronize the transmitting unit and the sensor system. The processor may determine a continual change in a distance between the subject and the subject tracking system so that a distance between the subject and the autonomous vehicle can be maintained.

According to another embodiment, a sensor system is used in concert with a transmitting system for tracking a subject. The sensor system may include one or more high frequency oscillators and multiple shift registers to measure a relative arrival time of an ultrasonic signal at a plurality of receivers, to thereby allow an ultrasonic signal arrival time to be calculated at multiple receivers without requiring a microcontroller dedicated to each receiver. A processor may receive the relative arrival time and determine a relative angle of the transmitting unit.

According to another embodiment, a subject tracking system for tracking a subject using a following sensor system is provided. The subject tracking system may include a subject based transmitting unit that may include an inertial measurement unit (IMU) and a communications link to the follower unit. The transmitting unit has a conical projection pattern which restricts the subject's orientation relative to the following sensor system.

According to another embodiment, a tracking system incorporating a subject based unit includes an inertial measurement unit (IMU) and a communications link to the follower unit. The US signal sent by the subject's transmitting unit has a conical projection pattern which restricts the subject's orientation relative to the following sensor system. If the subject changes orientation such as a spin or flip, or travels backwards the US signal can be lost by the follower. The IMU on the Subject unit can measure the subject's heading and velocity and detect changes in orientation relative to the direction of travel. A signal with the subject's heading and velocity is sent to the follower via the communication link.

According to another embodiment, a tracking system incorporating a subject based unit includes two or more emitters such that the sensor system can measure the orientation of the subject. The transmitting unit would include two emitters possibly one at each shoulder of the subject. The sensor system could detect if the subject stays in one place but rotates, the sensor system could then direct the autonomous vehicle to position itself always in the same orientation to the subject.

### BRIEF DESCRIPTION OF THE DRAWINGS

Aspects of the present disclosure is further described in the detailed description which follows in reference to the noted plurality of drawings by way of non-limiting examples of embodiments of the present invention in which like reference numerals represent similar parts throughout the several views of the drawings and wherein:

FIG. 1 is an illustration of the sensor system of a subject tracking system employed to record a subject riding a bike according to various embodiments.

FIG. 2 is an illustration of one example of an autonomous vehicle according to some embodiments.

FIG. 3 is a block diagram of an emitter of a subject tracking system according to some embodiments.

FIG. 4 is a block diagram of a following unit sensor system of a subject tracking system having four receivers according to one embodiment.

FIG. 5 illustrates a sensor system of a subject tracking system utilizing a high frequency oscillator and having three receivers according to one embodiment.

FIG. 6 illustrates a tracking subject system with an Inertial Measurement Unit (IMU) in addition to a ultrasonic emitter according to some embodiments.

FIG. 7 illustrates a synchronization scheme between an emitter and the sensor system according to some embodiments.

### DETAILED DESCRIPTION OF SOME EMBODIMENTS

Aspects of the present invention are described below with reference to flowchart illustrations and/or block diagrams of methods and/or apparatus (systems) according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to embodiments of the invention in the form disclosed. Many modifications and variations will be apparent to those of ordinary skill in the art without departing from the scope and spirit of embodiments of the invention. The embodiment was chosen and described in order to best explain the principles of embodiments of the invention and the practical application, and to enable others of ordinary skill in the art to understand embodiments of the invention for various embodiments with various modifications as are suited to the particular use contemplated.

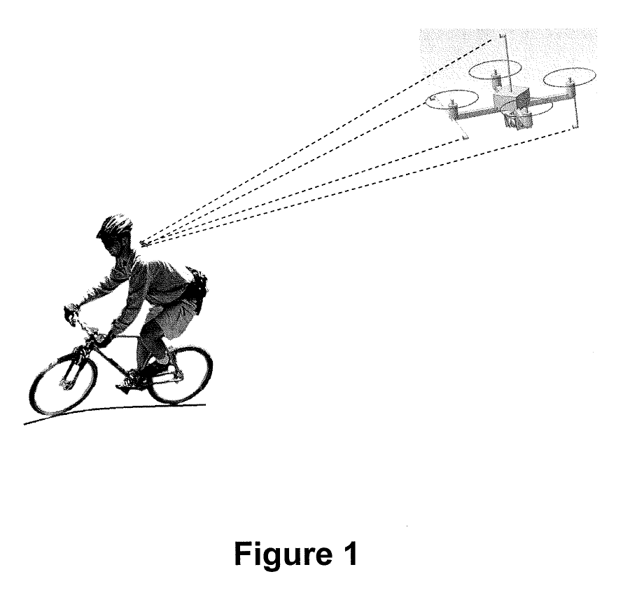

FIG. 1 is an illustration of a subject, in this case an athlete riding a bicycle, wearing a transmitter unit according to various embodiments of the invention; and an autonomous vehicle equipped with the sensor system according to various embodiments of the invention and a camera mounted to the vehicle for following the transmitter and recording the subject from a desired distance.

The subject tracking system (also referred to herein as “the tracking system” or just “the system”) may include at least two distinct components: a beacon (also referred to herein as an “emitter” or “transmitter”) and a sensor system. In some embodiments, the beacon is attached to subject and includes a precision timing device that emits regular US pulses.

In some embodiments, the sensor system is attached to an autonomous capable vehicle. The autonomous capable vehicle may be any unmanned vehicle, such as a drone, an unmanned aircraft, or the like. In one embodiment, the autonomous capable vehicle may be an autonomous helicopter, such as a four-propeller, autonomous helicopter (referred to herein as a “quad copter”). A quad copter is referred to hereout as the exemplary autonomous capable vehicle, but only for ease of illustration of the present invention and as such, the present invention should not be limited to only a quad copter.

The quad copter includes a camera, transducers that receive US pulses, a precision timing device that can be synchronized with beacon, and a microcontroller for relative distance, angle, and control algorithm calculations (i.e. computer implemented steps and processes).

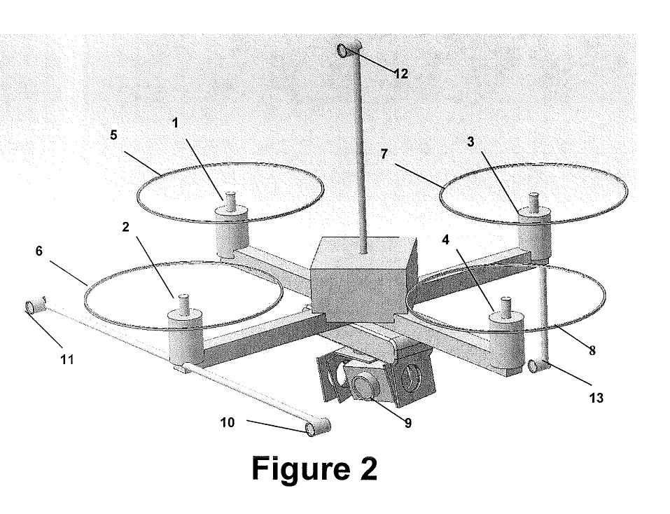

FIG. 2 is an illustration of one example of an autonomous vehicle, shown here as the quad copter (a four motor 1, 2, 3, 4 and propeller helicopter, with the propellers shown spinning 5, 6, 7, 8.) equipped with an exemplary sensor system of the present invention and a camera 9. The sensor system in this example includes four ultrasonic (US) receivers 10, 11, 12, 13. Here, the receivers are arranged in pairs: left 10 and right 11, and top 12 and bottom 13. Each pair is a fixed distance apart, in this case 24 inches. In this example, the left and right receivers are each located 12 inches from the mid plane of the vehicle on a common axis perpendicular to the vehicle's mid plane. The top and bottom receivers are also 24 inches apart, located on the mid plane of the vehicle, along an axis that is tilted 30° forward from vertical. This maximizes the receiver separation relative to the intended relative position of the subject 30° below the horizon.

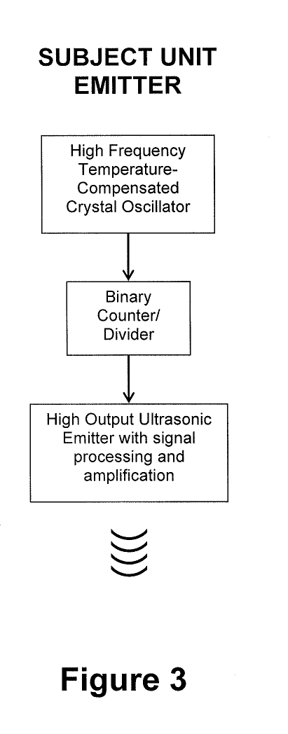

FIGS. 3-8 are provided herein and referred to in the below description of exemplary embodiments. Prior to discussing various components and operations of aspects of the application, below is a brief discussion of each drawing as a foundation for the description following thereof.

FIG. 3 is a block diagram of the subject unit. At start up the user (Subject) turns on the system. The oscillator creates a 32 kHz signal. The 32 kHz signal drives a 12 stage binary counter. The binary counter produces an 8 Hz trigger signal. The emitter generates ultrasonic signal pulses at 8 Hz. To shutdown the system the user turns the system off and the ultrasonic signals cease.

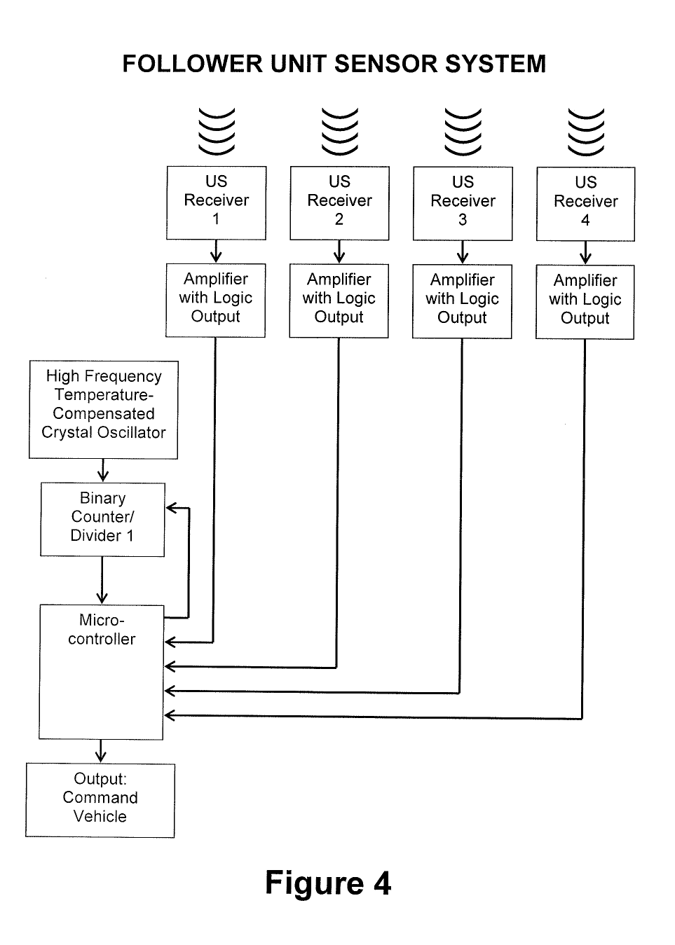

FIG. 4 is a block diagram of the sensor system. At initial set up the sensor system is turned on. The oscillator creates a 32 kHz signal which drives a 12 stage binary counter. The binary counter produces an 8 Hz signal. The microcontroller monitors the arrival time of the US signal from the subject unit at the primary US receiver: #1. The microcontroller resets the binary counter 1 so it is synchronized with US signal arrival time and then commands the vehicle to take off. After take off the sensor system cycles through each of the four receivers 1, 2, 3, and 4. The sensor system records the signal's arrival time at each sensor. The microcontroller calculates the emitter's change in distance and the relative angle of the emitter: either elevation (w) or azimuth (a). Based on the distance and the relative angle calculations the microcontroller commands the copter to follow emitter. The sensor system initiates landing commands when the US signals cease.

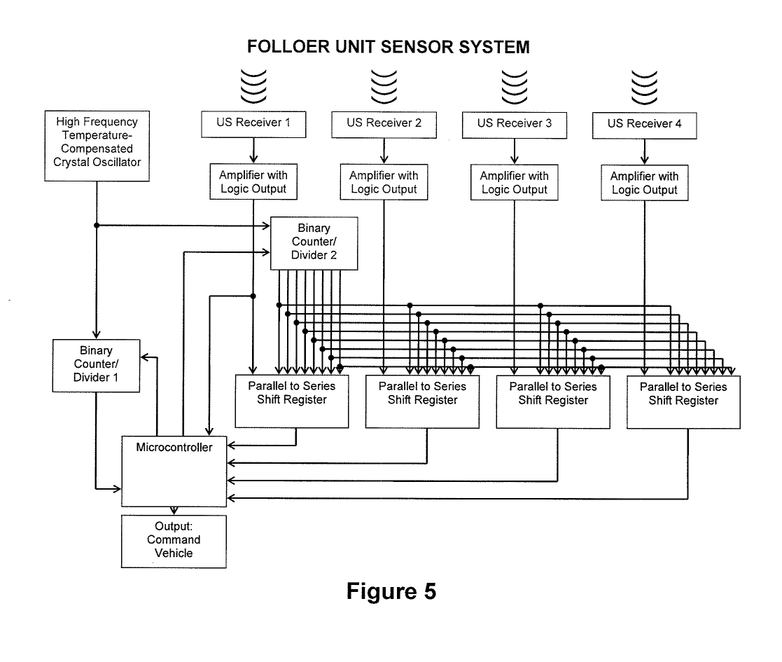

FIG. 5 illustrates a sensor system utilizing a high frequency oscillator. At start up the oscillator creates 32 kHz signal. The 32 kHz signal drives two 12 stage binary counters 1 and 2. Binary counter 1 produces an 8 Hz signal and binary counter 2 cycles through its eight least significant bits with the oscillator's 32 kHz signal. The microcontroller monitors US signal arrival time at US receiver 1 then resets binary counter 1 so it is synchronized with US signal arrival time and then commands the vehicle to take off. The microcontroller restarts binary counter 2 ahead of the US signal arrival time. Binary counter 2's eight bits are sent to the four shift registers. As the subject unit's US signals are received at each US receiver 1, 2, 3 and 4 the receiver's signal is amplified and a logic high is output. The logic high signal is sent to the corresponding shift register which locks its eight parallel input signals from binary counter 1 and creates a series output that encodes the arrival time. The microcontroller compares the arrival time outputs of the four shift registers to determine the relative angle of the emitter. The microcontroller compares the US signal's previous arrival time at US receiver 1 to the most recent arrival time to determine the change in distance of the emitter and when the next restart signal for binary counter 2 should be sent. Based on the distance and the relative angle calculations the microcontroller commands the copter to follow emitter. When the US signals cease the microcontroller initiates landing commands.

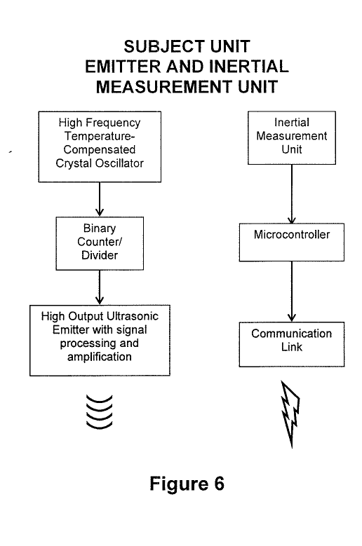

FIG. 6 illustrates a subject unit with an Inertial Measurement Unit (IMU) in addition to a US emitter. At start up the oscillator creates a 32 kHz signal which drives a 12 stage binary counter which converts this to an 8 Hz trigger signal. This signal triggers the emitter to generate ultrasonic signal pulses at 8 Hz. Additionally, a communication link from subject unit to follower is established. The inertial measurement unit (IMU) outputs the subject's orientation, acceleration, heading, and speed data. The microcontroller converts the IMU data for transmission via the communication link to the follower unit.

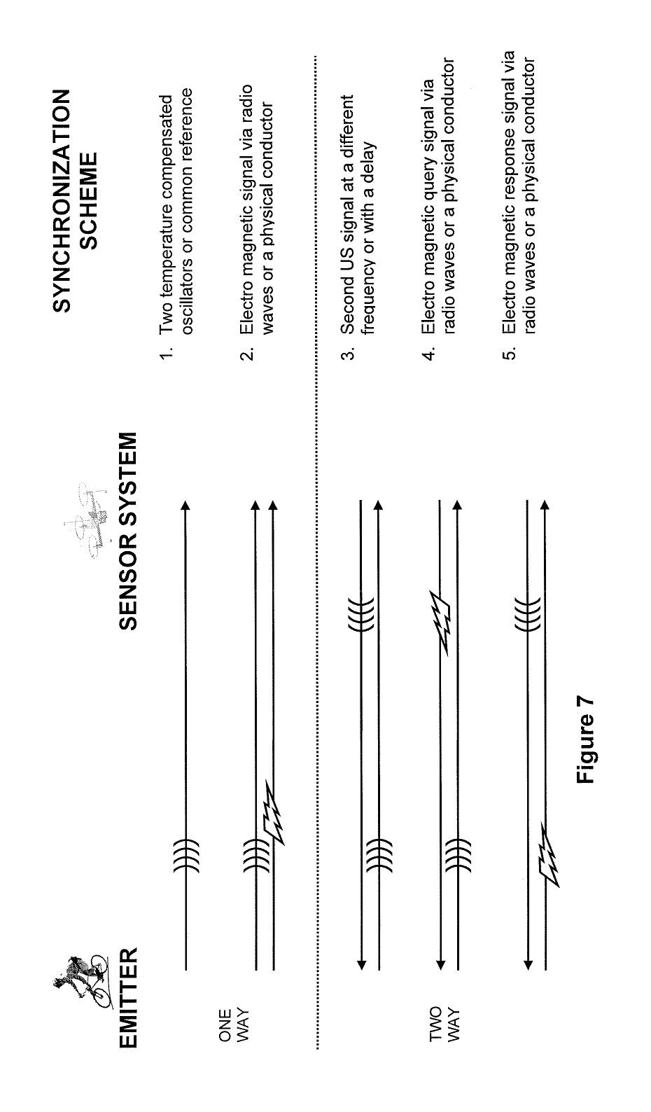

FIG. 7 is an illustration of some of the schemes that could be used to synchronize the emitter and sensor system. Synchronization is the key for detecting changes in distance. Scheme 1 is the methodology that has been prototyped. The details of each scheme are described in descriptions following the below discussions.

Referring now to FIGS. 3-7, the following descriptions provide more detail on various aspects of the present application.

In one example, to start up the tracking system, the sensor system and its quad copter with its camera system is powered on, the subject with the beacon backs off twenty feet from the front of the sensor system, the subject then turns on the beacon's emitter, the sensor system recognizes the beacon's signal, synchronizes its precision timer, commands the quad copter to turn on, and lifts off the ground.

Once off the ground, the tracking system shifts to its basic operation mode. The sensor system commands the quad copter to maintain the initial separation from the beacon and reach a height where the beacon's elevation angle is 30 degrees below the horizon, the subject with the beacon then moves away from the quad-copter either straight ahead or to the left or right, the sensor system commands the quad copter to follow the subject maintaining a constant distance and overhead angle so that the camera can keep the subject in the field of view.

The subject turns off the beacon to command the sensor system to land the quad copter. When the sensor system no longer receives the beacon's signal, it commands the vehicle to land.

Synchronization of the sensor system with the emitter may be accomplished by synchronization of both components by dual temperature compensated crystal oscillators. The ultrasonic measuring and tracking system is programmed to maintain the initial spacing between the beacon and the sensor system it measures at start up. In one working example, the system worked well at 10 to 30 foot nominal spacing.

In one example, the beacon's emitter is turned on first. Its temperature-compensated crystal oscillator (Maxim Integrated DS32 kHz) produces a 32.768 KHz square wave. Then its 12× binary counter (Texas Instruments CB4040B) divides down the high frequency oscillator output to an 8 Hz square wave. The 8 Hz square wave is used to trigger a US emitter (MaxBotix Inc. MB1360) via its number four input pin. The US emitter is triggered by the rising pulse of the square wave and produces a 42 kHz US burst eight times a second or every 0.125 seconds.

The sensor system may then be powered on. When turned on, the sensor system detects the emitter's signal and initiates its own synchronized timing signal. Like the beacon, the sensor system includes a temperature-compensated crystal oscillator that creates a 32.768 KHz square wave and a 12× binary counter that divides the wave form down to an 8 Hz square wave. The oscillator is initially powered off. When the sensor system's primary receiver (EngineeringShock.com 40 kHz Ultrasonic Transducer Receiver DIY Kit) receives an US pulse it outputs a 5 v or logic level high signal. The receiver's output signal is detected by the 16 MHz microcontroller (Arduino Uno).

The microcontroller's program uses a “do while” loop to monitor the receiver output voltage. The loop repeatedly checks the voltage level to see if it rises above of a threshold value. When a voltage above the threshold is detected a delay is initiated. The microcontroller starts the sensor system's own temperature compensated crystal oscillator so that the resulting 8 Hz wave form will be 180 degrees out of phase from the received wave form from the transmitter. The microcontroller's delay is tuned to account for the time it takes the processor to record the time and is 1/16th of a second or less. After the delay has expired the controller outputs a 5V or logic level high signal on a line connected to the oscillator's input trigger. This turns on the oscillator. The oscillator outputs a square wave that starts with the rising edge of a positive peak. The program keeps the oscillator's input trigger voltage level high so that the oscillator will continue to run. With its own oscillator and binary counter generating a square wave 180 degrees out of phase with the received emitter signal the sensor system is now synchronized with the emitter.

A temperature-controlled oscillator may be used because of its accuracy over time. Ten minute flight times are achievable with hobby style quad-copters. During a flight the sensor system needs to be able to measure the location of the emitter the entire time with limited error. Each temperature controlled oscillator used in the working example has an accuracy of +/−2 ppm, or +/−0.0012 seconds per ten minutes. There were two oscillators used in this example, one of the emitter and one of the sensor system. This doubles the error or halves the accuracy to +/−0.0024 seconds.

To consider this error's impact on the distance calculations the speed of sound, 1116 ft/second, should be considered. At the end of a ten minute flight a possible error of 0.0024 seconds corresponds to 2.6 feet. This is acceptable when the quad copter is nominally 20 feet away. For comparison the micro controller of the working example has its own clock but it was found to have an accuracy of +/−20 ppm, or +/−0.012 seconds per ten minutes. At the end of a ten minute flight a possible error of 0.012 seconds corresponds to 13 feet. This may not be acceptable when the quad copter is nominally 20 feet away. Additionally, this ignores the error that may be added by the emitter's timer. The micro controller's clock may be acceptable for calculations based on short periods of time like that between pulses, 0.125 seconds.

The sensor system measures the relative distance of the emitter, or in other words the deviation from the initial distance. The sensor system's 8 Hz square wave or timing constant may be used as a standard against which changes in signal received from the emitter are measured. The 16 MHz microcontroller uses its own internal clock to measures the time between the rising pulse of the timing constant square wave and the next rising pulse received from the transmitter. The microcontroller uses a “do while” loop to capture the clock time of the sensor system's timing constant 8 Hz square wave. The loop repeatedly checks the voltage level to see if it rises above of a threshold value, when the voltage is high enough the micro controller's clock time is recorded. Next the microcontroller captures the arrival time of the signal from the transmitter. Similarly the microcontroller's program uses a “do while” loop to monitor the signal from the emitter. The loop repeatedly checks the voltage level to see if it rises above of a threshold value, when the voltage is high enough the micro controller's clock time is recorded. The microcontroller then calculates the time gap or lag between the timing constant and the received signal by subtracting the peak time of the timing constant from the peak time of the received signal. At start up the signal from the transmitter lags the sensor system's timing constant by 1/16th of a second. If the lag between waveforms increases the distance between the transmitter and sensor system has increased. Similarly if the lag decreases the distance between has decreased. This deviation from the initial lag or error is used to calculate the appropriate commands for the vehicle.

The sensor system detects the relative angle of the emitter with its array of receivers. In some embodiments, the receivers are arranged in two pairs, one horizontal 10, 11, and one near vertical 12, 13; these measure the azimuth and elevation angles respectively. The angle between the emitter and the line defined by a pair of receivers can be determined by the difference in the arrival time of the emitter's signal at each receiver. The methodology for these calculations is based on the assumption that the difference in the arrival time of the emitter's signal at each receiver in the pair is proportional to the Cosine of the emitter's angle. This methodology assumes that the wave front of the US signal is planer instead of spherical. This method has less than 0.05% error when the emitter's distance from the pair of receivers is at least 5 times the spacing between the two receivers. The error is reduced when the emitter is further away. This system has a receiver spacing of 2 feet and is intended for emitter distances of 10-30 feet.

To measure the azimuth and elevation angle of the emitter the arrival time at each receiver is calculated. The arrival time of the emitter signal at each receiver is calculated by the micro controller using two while loops as described earlier. The first loop is for the sensor system's timing constant and the second for the US signal's arrival time. The micro controller measures the US signal arrival time at each receiver one at a time. After a signal arrives at one receiver the microcontroller steps to the next. The emitter sends out eight pulses per second and there are four receivers, therefore each receiver is checked twice a second. The arrival time of the nth signal at the primary receiver is measured first, this continues for all four receivers. The primary (R1) or top receiver, receives signal “n”; then the second (R2) or left side receiver, receives signal “n+1”; then the third (R3) or bottom receiver, receives signal “n+2”; and lastly the fourth (R4) or right side receiver, receives signal “n+3”. After fourth receiver the microcontroller cycles back to the first. Each receiver measures the arrival time of a different US pulse. The angle calculations are made with distance calculations made from pulses that are fourth of a second apart such as “n” and “n+2”. This approach leverages the fact that the angular position of the subject doesn't change significantly in one fourth of a second.

Elevation (ψ), the relative angle in the vertical plane, is measured by the difference in arrival time between the top 12 and bottom 13 US receivers. The top and bottom US receivers are located on the vehicle's median plane, along an axis inclined 30 degrees from vertical, such that the top receiver is forward and the bottom receiver is toward the rear of the vehicle. These receivers may be spaced 2 feet apart. The micro controller calculates the elevation angle to the subject twice a second. This elevation angle measurement may be used to calculate the altitude needed to maintain the vehicle's relative overhead following position as the subject moves up or down.

Similarly azimuth (α), the relative angle in the horizontal plane, may be measured by the difference in arrival time between the left side 10 and right side 11 US receivers. In one example, the left side and right side receivers are located on a transverse axis of the vehicle. These receivers are spaced 2 feet apart. The micro controller calculates the azimuth angle to the subject twice a second. The azimuth angle measurement is used to calculate the angle needed to steer the vehicle left or right in the horizontal plane to follow the subject with its beacon as it turns.

To control the vehicle the sensor system calculates the error between the actual and the desired vehicle position relative to the emitter. The distance error is proportional to the deviation of the US signal's arrival time. The elevation angle error is found by subtracting the desired 30° elevation angle from the measured elevation angle. The azimuth angle error is found by subtracting the desired 0° (straight ahead) angle from the measured azimuth angle.

In basic operation the sensor system's microprocessor uses a series of computer implemented processes (also known as the “control algorithm”) to calculate the output commands for the vehicle. In some embodiments, the control algorithm takes input from the vehicle's flight controller and the sensor system. Form the sensor system: distance error, elevation angle error, and azimuth angle error data is used. From the flight controller data: accelerometer data, electronic compass data, and GPS data may be considered. The control algorithm uses a PID (proportional, integral, and derivative) scheme. These three components consider the error data in different ways: proportional considers the current error, integral the past errors, and derivative the rate of past errors.

The sensor system's control algorithm outputs commands to the autonomous capable vehicle to follow the emitter (see for example FIG. 5). The outputs commands consist generally of: vertical (upward or downward), horizontal (forward or backward), and rotation (left or right). The micro controller outputs commands formatted to interface with the vehicle's flight control system. Several formats can be used and others can be created by programming: pulse width modulation (PWM), logic (high/low) voltage, and Serial Peripheral Interface (SPI). Output commands can also be formatted to interface directly with the vehicle's control systems: throttle servos; roll, pitch, and/or yaw servos; and speed controllers.

As should be understood, the present invention is not limited herein and various other embodiments are possible. For example, below are some alternate or additional embodiments and/or implementations.

Tracking performance could have a faster microcontroller than the one used in the specific working example. The working example system was built with a microcontroller that uses a 16 MHz processor. This system was able to measure emitter movements on the order of three inches. Knowing that the speed of sound is 1116 feet per second; this indicates that the microprocessor was able to distinguish time steps of 0.0002 seconds. This resolution is related to processor speed. A micro controller with a faster processor will be able to recognize smaller emitter movements, which improves the sensor system's ability to track the emitter.

Additional microcontrollers could also be used to improve performance. Each pair of receivers could be monitored by a dedicated microcontroller. This would allow both angle measurements to be made simultaneously based on two consecutive emitter signals “n” and “n−1”. Furthermore, each receiver could have a dedicated microcontroller this would further improve the system's response time and accuracy. This approach would allow the calculation of both angles every nth emitter signal. This would improve the accuracy of the system's angular measurements.

The arrival time at multiple US receivers can be determined using a high frequency oscillator and multiple shift registers instead of a microcontroller dedicated to each US receiver. This option is less expensive due to the lower cost of high frequency oscillators and shift registers compared to microcontrollers. Additionally, the system already includes a high frequency temperature compensated oscillator to synchronize the subject's transmitting unit and the sensor system for calculating changed in distance between the two units. A single or multiple high frequency oscillators (not necessarily temperature compensated) could also be used to measure the difference in signal arrival time at each sensor. FIG. 5 illustrates a sensor system utilizing a high frequency oscillator, and is described in the description of the drawings section.

The working example was built up with “do it yourself” components. Dedicated circuitry produced in volume would achieve greater performance at lower costs.

A sensor system with three non-collinear receivers could be used to determine the direction of the emitter instead of four. This methodology assumes that the emitter is in front of the sensor array. The three receivers may be arranged in an equilateral triangle to maximize their spacing. The plane of the receiver triangle would be normal to a line through the centroid of the triangle and the intended position of the emitter. Similarly to the system described earlier, the time delay between the reference 8 Hz signal and that detected by each of the three receivers is measured. The three delay times are used to calculate the relative position of a plane normal to, twenty feet from, and axially aligned with the emitter. The control system then may calculate the necessary commands to position itself so that the three sensor array is twenty feet from and axially aligned with the emitter

Different embodiments are also possible relative to the US emitters. Emitters with a stronger signal would allow the vehicle to follow at a greater distance. Emitters with a higher pulsing frequency would give greater accuracy and reduce the sensor system's delay in recognizing the emitter's changes in position. Emitters with a wider dispersion pattern would provide the sensor system greater visibility of the subject regardless of their orientation. The prototype used an 8 Hz pulsing frequency due to its emitter's 10 Hz limitation.

Different embodiments are also possible relative to the US receivers. Receivers with greater sensitivity would allow the sensor system and its vehicle to follow at a greater distance.

While the working example was developed with a subject unit with a single emitter, multiple emitters could be utilized by the subject unit to add additional functionality to the system. There are multiple ways that multiple emitters could be utilized: synchronized and alternating. Synchronized emitters would allow the subject greater freedom of movement such as spinning. Alternating emitters would allow the sensor system to detect if the subject spins.

US emitters may have a narrow signal emission pattern. For this application, a widely spread signal pattern may be useful as the subject may turn and direct its emitter's signal away from the sensor system. Multiple synchronized emitters arranged to create a signal pattern that radiates in all or more directions would be useful. This emitter arrangement would allow the subject greater freedom of movement allowing them to turn or spin and maintain synchronization with the sensor system

The orientation of the subject could be detected with the use of multiple alternating emitters. This could be accomplished with two emitters placed on the subject in horizontally separate locations. Relative to the sensor system the emitters might be in line with each other and the sensor system, lined up perpendicular to the sensor system, or any other orientation. The emitters would alternate sending out US signals: emitter A then emitter B, then repeating. The sensor system would detect the location of each emitter at start up and command the vehicle to maintain its initial orientation relative to both emitters. When the subject spins such that their orientation changes the sensor system would command the vehicle to reestablish its position relative to the subject's new orientation.

The subject unit with an Inertial Measurement Unit (IMU) and a communication link with the follower, in addition to a US emitter, is depicted in FIG. 6 and described in the description of the drawings section. The US signal sent by the subject's transmitting unit has a narrow signal emission pattern. The ultrasonic signal's transmission pattern places orientation restrictions on the subject. If the subject changes orientation such as a spin or flip, or turns and travels backwards the US signal can be lost by the follower. IMUs typically include a 3-axis gyro, a 3-axis accelerometer, and a 3-axis magnetometer or GPS these components working together can detect changes in orientation relative to the direction of travel. IMUs are also referred to as Inertial Navigation Systems. An IMUs 3-axis accelerometer can detect the phenomena of weightlessness caused by falling or jumping through the air. In this alternative implementation the subject unit would send a signal with the IMU's data to the follower via the communication link. There are multiple schemes for incorporating an IMU and a communication link into the subject unit.

In the first scheme, the microcontroller monitors the IMU's orientation and heading data. If the subject's orientation deviates from its heading its heading, speed, and/or acceleration data may be sent to the follower by the communication link.

In the second scheme the communication link continually sends the IMU's acceleration data to the follower so it can detect a jump. While the microcontroller monitors the IMU's orientation and heading data. If the subject's orientation deviates from its heading its heading and speed data is also sent to the follower by the communication link.

In the third scheme the communication link constantly sends all of the IMU data to the follower.

Quad copters can be equipped with gimbal systems to create a level platform for a camera while the quad copter tilts and rolls in flight. These gimbals can utilize control signals from the quad copter's flight controller to maintain an orientation parallel to the ground. The gimbal can be set up to maintain a 30° down angle to match the sensor system's targeted angle for the subject.

To adjust the follower's distance a tracking system that incorporates an adjustable synchronization delay could be incorporated. The subject unit and sensor system are synchronized by their similar high frequency oscillators. The sensor system measures the delay between its synchronization signal and the US signal's arrival at the primary receiver to determine a change in distance. The initial delay could be set for 0.02 seconds or roughly the time it takes sound to travel 20 feet. The sensor system works to keep this 0.02 second delay constant so that the initial spacing is maintained. With an adjustable synchronization delay the user could adjust the desired spacing by a user interface on the subject unit. Based on used input, the subject unit sends a signal to the sensor system to adjust its initial delay. If the user wants the follower to decrease its following distance the initial delay could be decreased to 0.19 seconds and the follower would be controlled to follow 1 foot closer. In the case of a 20 foot initial spacing the follower would now follow at 19 feet instead of 20 feet. Similarly, if the user desires the follower to increase its following distance the initial delay could be increased.

Some embodiments are as follows:

A1. A tracking system utilizing one or more dedicated high frequency oscillators in a transmitting unit and one or more in the sensor system to synchronize their systems, this synchronizing of the two systems allows a change in the distance between the two components to be determined. This is different than the other patents which measure the distance between the two systems. The measurement of a change in distance is enough keep a constant spacing.
B1. A sensor system utilizing one or more high frequency oscillators and multiple shift registers instead of a microcontroller dedicated to each US receiver to measure the relative arrival time of a US signal at one or more receivers. This approach allows the US signal arrival time to be calculated at multiple receivers without a microcontroller dedicated to each receiver. Measuring the difference in the US signal's arrival time at multiple receivers allows the relative angle of the transmitting unit to be determined. Using the same high frequency oscillator to synchronize the sensor system with the transmitting unit and measure the difference in arrival times reduces system costs.
C1. A tracking system incorporating a subject based unit that includes an inertial measurement unit (IMU) and a communications link to the follower unit. The US signal sent by the subject's transmitting unit has a conical projection pattern which restricts the subject's orientation relative to the following sensor system. If the subject changes orientation such as a spin or flip, or travels backwards the US signal can be lost by the follower. The IMU on the subject unit can measure the subject's heading and velocity and detect changes in orientation relative to the direction of travel. A signal with the subject's heading and velocity is sent to the follower via the communication link.
D1. A tracking system incorporating a subject based unit that includes two or more emitters such that the sensor system can measure the orientation of the subject. The transmitting unit would include two emitters possibly one at each shoulder of the subject. The sensor system could detect if the subject stays in one place but rotates, the sensor system could then direct the autonomous vehicle to position itself always in the same orientation to the subject.
E1. A tracking system that incorporates an adjustable synchronization delay. A user adjustable synchronization delay via the subject unit's user interface and its communication link to the following sensor system would allow the distance the follower maintains to be changed.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that embodiments of the invention have other applications in other environments. This application is intended to cover any adaptations or variations of the present invention. The following claims are in no way intended to limit the scope of embodiments of the invention to the specific embodiments described herein.

I claim:

1. A subject tracking system to track a subject, the subject tracking system comprising:
a transmitting unit that is configured to be located with the subject during use and comprising at least one first dedicated high frequency oscillator;
an autonomous vehicle comprising a sensor system comprising at least one second dedicated high frequency oscillator to continually synchronize the transmitting unit and the sensor system; and
a processor that continually determines changes in the distance between the subject and the subject tracking system so that a distance between the subject and the autonomous vehicle can be maintained.

2. The subject tracking system of claim 1, wherein the autonomous vehicle further comprises the processor.

3. The subject tracking system of claim 1, wherein the processor also provides feedback to the autonomous vehicle regarding the change in the distance so that the autonomous vehicle can change it's position and speed to maintain a predetermined distance between the autonomous vehicle and the subject.

4. The subject tracking system of claim 1, wherein the autonomous vehicle is configured to receive a predetermined distance that is to be maintained between the subject and the autonomous vehicle.

5. The subject tracking system of claim 4, wherein the processor also provides feedback to the autonomous vehicle regarding the change in the distance so that the autonomous vehicle can change it's speed to maintain the predetermined distance between the autonomous vehicle and the subject.

6. The subject tracking system of claim 4, further comprising an adjustable synchronization delay that allows the subject to adjust the predetermined distance.

7. The subject tracking system of claim 1, further comprising a subject based unit that comprise two or more emitters such that the sensor system measures an orientation of the subject.

8. The subject tracking system of claim 7, wherein the two or more emitters are attached to the shoulders of a person, where the person is the subject.

9. The subject tracking system of claim 7, wherein the sensor system detects if the subject stays in one place but rotates, and wherein the sensor system directs the autonomous vehicle to position itself always in the same orientation to the subject in response to determining that the subject orientation has changed.

10. A sensor system used in concert with a transmitting system for tracking a subject, the sensor system comprising:
one or more high frequency oscillators; and
multiple shift registers to measure a relative arrival time of an ultrasonic signal at a plurality of receivers, to thereby allow an ultrasonic signal arrival time to be calculated at multiple receivers without requiring a microcontroller dedicated to each receiver,
wherein the relative arrival time is received and a relative angle of the transmitting unit is determined.

11. A subject tracking system for tracking a subject using a follower comprising a following sensor system, the subject tracking system comprising:
a subject based transmitting unit that is associated with the subject and that comprises:
an emitter that transmits a signal to the follower indicating information about a subject's movement of travel to guide the follower relative to the subject based transmitting unit;
an inertial measurement unit (IMU) that detects changes in direction of travel, change in speed, and change in orientation of the subject; and
a communications link to transmit data from the IMU to the follower sensor system,
wherein the IMU data received by the is used by the follower to guide the follower relative to the transmitting unit if the signal from the emitter is interrupted.

12. The subject tracking system according to claim 11, wherein the IMU data is used by a follower to guide the follower in order to maintain a distance between the transmitting unit and the sensor system if the signal from the emitter is interrupted.

13. The subject tracking system according to claim 11, wherein the communications link comprises an antenna.

14. The subject tracking system according to claim 11, wherein the transmitting unit may have a conical projection pattern which restricts the subject's orientation relative to the following sensor system.

15. The subject tracking system of claim 11, wherein the IMU measures a subject's change in direction of travel, change in speed, and change in orientation, and wherein a signal with the subject's speed and direction is sent via a communication link.
